(19) United States
(12) Patent Application Publication
(10) Pub. No.: US 2025/0216272 A1
(43) Pub. Date: Jul. 3, 2025

(54) THERMOCHROMIC INDICATOR ON TEST TUBE

(71) Applicant: MTC Bio Inc., Sayreville, NJ (US)

(72) Inventors: Michael J. Demsia, Holmdel, NJ (US); Chaoying Wang, Taizhou (CN)

(21) Appl. No.: 19/001,821

(22) Filed: Dec. 26, 2024

Related U.S. Application Data
(60) Provisional application No. 63/616,167, filed on Dec. 29, 2023.

(51) Int. Cl. G01K 11/12; B01L 3/00; G01K 13/12

(52) U.S. Cl. CPC G01K 11/12; B01L 3/50825; G01K 13/12

(57) ABSTRACT

An indicator or visual monitor on a tube, including, for example, a laboratory tube, a test tube, a culture tube, a blood tube, a centrifuge tube, or another tube is provided. The indicator or visual monitor can be provided at a section or multiple sections of the tube and allows monitoring whether the tube and material at that particular section or multiple sections are at a certain temperature or not above a certain temperature. The indicator can comprise ink, which can be applied to the tube or a portion of the tube during manufacture.

### CROSS-REFERENCE TO RELATED APPLICATIONS

The present application claims the benefit of U.S. Provisional Patent Application No. 63/616,167, filed Dec. 29, 2023, the entire contents of which are incorporated herein by reference as if repeated herein.

In one aspect, the present disclosure provides an indicator or visual monitor on a tube, including, for example, a laboratory tube, a test tube, a culture tube, a blood tube, a centrifuge tube, or another tube.

The description of the embodiments and attached figures set forth in this disclosure serves only for a better understanding, without limiting scope. A person skilled in the art, after reviewing the present disclosure could make adjustments or amendments to the attached figures and above described embodiments that would still be covered by the present disclosure.

The present disclosure is not limited to particular systems, which may, of course, vary. It is also to be understood that the terminology used herein is for the purpose of describing particular embodiments only, and is not intended to be limiting.

### BRIEF DESCRIPTION OF DRAWINGS

The features and advantages of the example embodiments described herein will become apparent to those skilled in the art to which this disclosure relates upon reading the following description, with reference to the accompanying drawings. Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures (FIGs.) are listed below.

FIG. 1 shows a tube with an exemplary thermochromic freezing indicator according to a first exemplary embodiment.

FIG. 2 shows the tube of FIG. 1 that has been subjected to the certain temperature, such as freezing.

FIG. 3 shows a second exemplary embodiment of a tube with a thermochromic freezing indicator in a central portion of the tube.

FIG. 4 shows exemplary tubes according to the disclosure disposed in an ice bath.

FIG. 5 shows exemplary prior art tubes where the entire tube undergoes a color

change.

### DETAILED DESCRIPTION

Some general terminology descriptions may be helpful and are included herein for convenience and are intended to be interpreted in the broadest possible interpretation. Elements that are not imperatively defined in the description should have the meaning as would be understood by a person skilled in the art.

In at least one exemplary embodiment, the indicator includes an amount of thermochromic ink that is printed, provided on, or otherwise affixed to the tube. In at least one exemplary embodiment, the thermochromic ink is provided at a specified region of the tube, such as a lower portion of the tube. While the thermochromic ink could be provided over a large section of the tube, including over the entire tube, the tube in the exemplary embodiments shown in the figures provide an indicator at a lower portion of the exemplary tube. The inventive indicator is not intended to be limited to the embodiment shown and instead, the figures provide a representation of exemplary embodiments of indicators according to the present disclosure.

As shown in the exemplary figures, the indicator comprises a thermochromic block printing where a thermochromic material is added to the regular printing ink to give the block the ability to sense temperature changes and change color. The thermochromic transition of the thermochromic blocks is reversible to provide a visual indication of the temperature of the test tube and contents, allowing researchers to effortlessly monitor and maintain the desired sample temperature throughout an experiment. The ability to monitor temperature throughout an experiment greatly reduces the effort of the researcher.

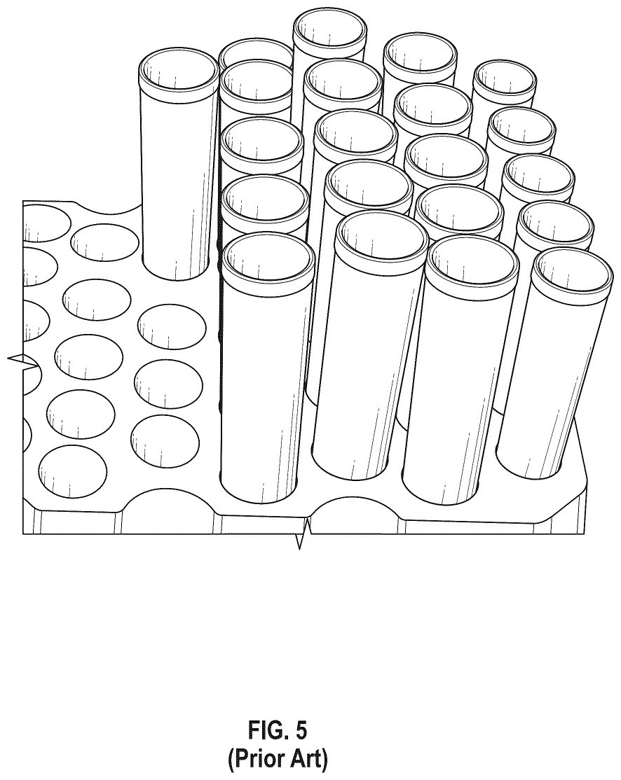

Other tubes have proposed the use of thermochromic material mixed in with the plastic resin from which the tube is formed. However, having the entire tube turn color when the material and/or tube are at a certain temperature, such as at a freezing temperature, suffer from several disadvantages (see prior art tubes shown in FIG. 5). For example, one disadvantage of the entire tube turning color when at a certain temperature, such as freezing, is that any interaction with an upper portion of the tube, e.g., for example, by a researcher's hand or by an instrument wielded by a researcher, could alter the experiment or at minimum lower the confidence in the experiment. To wit, any interaction with an upper portion of the tube, e.g., for example, by a researcher's hand or by an instrument wielded by a researcher, could warm the tube at an upper portion while the material in the lower portion were otherwise not raised in temperature above freezing. If this warming occurred during an experiment, a portion of the tube could begin to change color and the researcher would not be able to rely on the visual indication of the temperature in the tube—even though the material at the lower portion of the tube may still be freezing. In contrast, if only a portion of the tube included thermochromic material, such as a lower portion, the researcher could interact with an upper portion of the tube, such as with their hand or an instrument, and monitor and/or be aware by visual inspection that the material in the tube was maintained at a desired temperature (such as freezing) throughout the entire experiment because the lower portion of the tube did not change color.

A second disadvantage of the entire tube turning color when at a certain temperature, such as freezing, is that different types of experiments are possible if only a portion or portions of a tube turn color. For example, providing only a portion of a tube with thermochromic material could provide a variety of options for experiments that would not be available if the entire tube turned color when at a certain temperature. If a researcher were interested in the reaction of a less than full tube, the thermochromic material could be positioned only at a certain level, such as, for example, the middle of a tube, a third of the distance from either end of the tube, at an upper portion of the tube, or at a lower portion of the tube, allowing an experiment to be performed with confidence, where the portion of the tube of interest could be monitored and/or visually inspected to ensure that the portion being measured was maintained at a certain temperature throughout the experiment.

Additionally, more than one thermochromic material portion could be provided on a single tube to allow experiments involving change of temperature over a period of time, which experiments would not be possible with any degree of certainty if the entire tube changed color at a certain temperature. Further still, thermochromic materials that changed color at different temperatures could be provided in more than one portion of the tube temperature according to the present disclosure. In contrast, measurements of different temperatures would be unachievable if the entire tube changed color at a certain temperature. In one example, a first thermochromic material could be provided at a lower portion of the tube that changed color at a first temperature, and a second thermochromic material could be provided at an upper or middle portion of the tube that changed color at a second temperature. The first temperature and the second temperature could be the same or different, depending on the experiment or the interaction being measured/observed.

Another clear disadvantage to the entire tube turning color when at a certain temperature by mixing the thermochromic material with the resin forming the tube is the loss of maximum transparency. Researchers typically demand the clearest tubes possible. The addition of a thermochromic material lessens the clarity of the formed tube, which is contrary to industry demand for clear tubes intended to provide the best visibility of tube contents. If the entire tube undergoes a color change, it could be difficult to observe the contents inside the tube. For example, in microbiological cultures or cell culture observations, having a clear view inside the tube is crucial. A full-tube color change might interfere with this visual observation. Further, a full-tube color change could create a potential chemical interference. For example, in certain chemical or biochemical experiments, adding additional chemical substances (like thermochromic powder) might interfere with the experimental outcomes. As a further example, in certain types of chemical reactions or biological assays, the purity of the tube's environment is critical, and any extra chemical substance might affect the accuracy of the results. Even further, a full-tube color change could create durability issues as the color-changing ability of the powder might be affected by long-term use or under extreme conditions, leading to unstable or unreliable results. For example, in cases where tubes need to be used for an extended period or repeatedly, the durability issues could be a significant consideration. Even further still, a full-tube color change could create challenges in reproducibility and standardization. For example, the properties of thermochromic powder may vary by brand or batch, which could affect the reproducibility and standardization of experiments—in experiments requiring high consistency, this variability could pose a problem. In contrast, the use of a patch, label, or square would allow the tube to be as clear as possible without thermochromic material lessening or otherwise impacting clarity.

In another aspect, the present disclosure includes unique designs or representations to indicate temperature change. For example, by providing a section of thermochromic material in a specific area, a researcher is able to monitor at a glance that the tube and material are at a certain temperature. The exemplary figures provide designs and artwork provided specifically to ease, amplify, and confirm temperature. These designs and artwork allow quick confirmation by a researcher of a desired temperature. The exemplary symbols and representations allow monitoring by a variety of researchers, regardless of native language, training, age, or ability. For example, a square or patch is provided that contains a representation of snowflake, a depiction of a thermometer, and/or the words: “Blue visible at 0 degrees C.” (or other similar verbiage). One would note that although these representations are all shown together in the exemplary figures, single or combinations of these representations could be utilized.

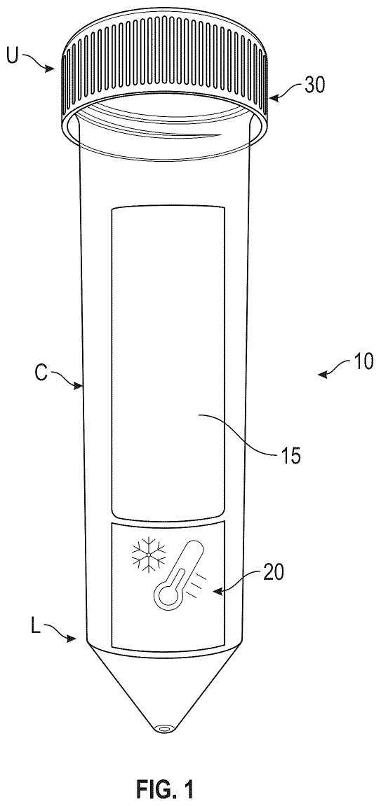

In FIG. 1, one exemplary embodiment of a tube 10 with an exemplary

thermochromic freezing indicator 20 is shown, with the indicator comprising a small square that has not been subjected to freezing temperatures. In this exemplary design, the indicator 20 is shown near the bottom or lower portion L of the tube 10, with a label 15 disposed in a central portion C of the tube. A cap 30 can be provided to secure the top or upper portion U of the tube 10, and can be removably secured via screw threads, a lip to allow the cap 30 to be snapped on or off the tube 10, or can involve other attachment options. The tube 10 shown in FIG. 1 is at an ambient temperature or otherwise not being subjected to a certain temperature, such as freezing, to turn the square indicator 20 from translucent to blue. The square indicator 20 could be a different size or configuration indicator and could be formed as a sticker, adhesive, ink, or integral portion of the tube 10. For example, the indicator could be a circular or rectangular sticker or could be an inset or outwardly extending portion of the tube 10.

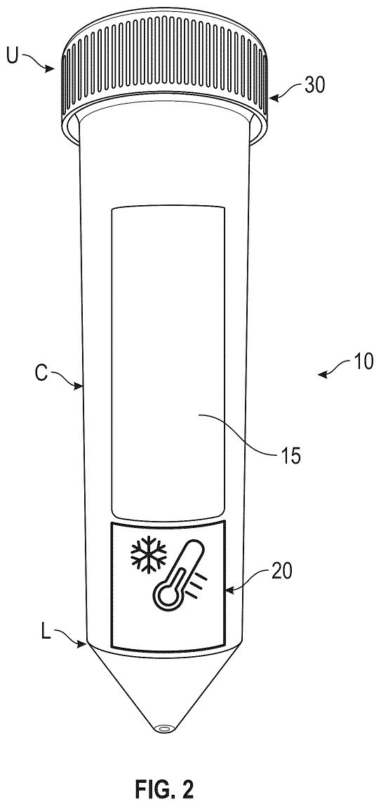

FIG. 2 shows the tube 10 of FIG. 1 that has been subjected to the certain temperature, such as freezing. The indicator 20 of the tube 10 has turned from translucent to blue to provide a visual indication that the lower portion L of the tube 10 is at, or below, freezing.

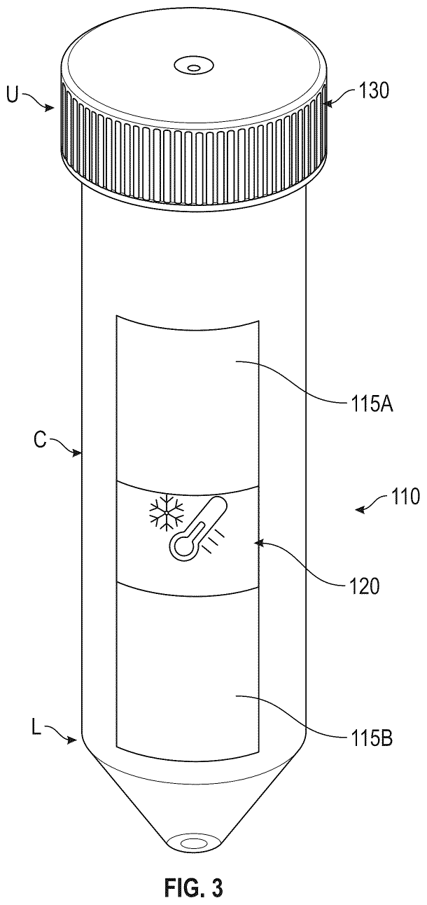

FIG. 3 shows another exemplary embodiment of a tube 110 with a thermochromic freezing indicator 120 in a central portion C of the tube110. The indicator 120 in this embodiment is a small square patch of ink that turns from translucent to blue, e.g, for example, when frozen. The tube 110 shown in FIG. 3 is at an ambient temperature or otherwise not being subjected to a certain temperature, such as freezing, to turn the indicator 120 from translucent to blue.

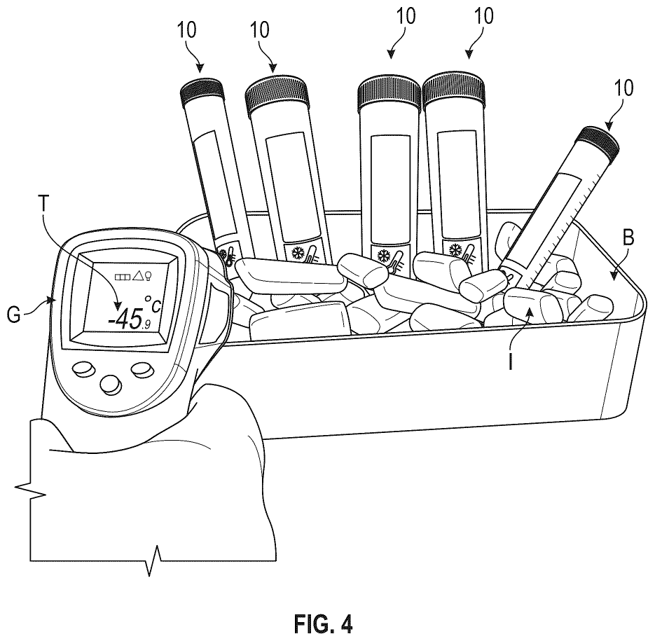

FIG. 4 shows exemplary tubes 10 according to the disclosure disposed in ice I in an ice bath B. As shown in FIG. 4, the tubes 10 have been cooled to the certain temperature, here freezing, and the indicators 20 have turned from translucent to blue. The discoloration of the thermochromic test tubes 10 on ice or dry ice are evident through the indicator, patch, label, ink, etc., that the temperature T shown on the temperature gauge G is at minus 45.9 degree Centigrade.

FIG. 5 shows exemplary prior art tubes where the entire tube undergoes a color change.

In other embodiments, the patch can comprise a thermochromic block, printing, or ink into which thermochromic material has been added to provide the ability to sense temperature changes and change color. This change of color is reversible, allowing the tube to be used multiple times. The color provides a visual indication of the temperature of the tube and the contents of the tube. The visual indication can allow, for example, a researcher to monitor effortlessly the tube and to maintain the desired sample temperature throughout an experiment. In at least one aspect, the present disclosure provides for the use of thermochromic ink onto a tube. Further, the present disclosure provides for the use of thermochromic ink located on a tube, with the exemplary positions of the ink, patch, square, or other representation shown in the figures not intending to be limiting in any manner. Instead, the thermochromic ink can be positioned in a variety of positions, can include multiple identical, similar, or distinct instances—including on any individual tube, and can be any design or representation with inventive aspects of the present disclosure.

In at least one exemplary embodiment, the “thermochromic block” printing can be formed from Thermochromic MC Pigment together with Printing Inks, without any other materials, such as, plasticizers, modifiers, etc. Additional details of Thermochromic MC Pigment can be found on MSDS-Thermochromic MC Pigment 0C Violet. Additional details of color change can be found at the Runlab thermochromic test tubes introduction.

In one aspect, a method of assessing temperature change is provided. The method comprising: providing a test tube comprising at least three sections, with the three sections including an upper section, a central section, and a lower section; providing at least one thermochromic indicator on at least one of the at least three sections but less than all of the at least three sections; wherein the at least one thermochromic indicator comprises a thermochromic material that changes from a first color to a second color at a certain temperature; and lowering the test tube below the certain temperature to change the at least one thermochromic indicator to the second color. In another aspect, the at least one thermochromic indicator is disposed on the central section and the lower section of the test tube. In another aspect, the at least one thermochromic indicator is disposed on the central section only. In another aspect, the at least one thermochromic indicator is disposed on the lower section only. In another aspect, the first color is white or opaque. In another aspect, the second color is blue. In another aspect, the certain temperature is 0° C. In another aspect, the method further comprises monitoring whether the at least one thermochromic indicator changes from the second color to the first color during an experiment. In another aspect, the method further comprises: handling the top portion with an instrument or user's hand; and monitoring whether the at least one thermochromic indicator changes from the second color to the first color during handling. In another aspect, the at least one thermochromic indicator comprises ink that is applied during manufacture of the test tube.

In another aspect, a combination is provided that comprises: a test tube comprising at least three sections, with the three sections including an upper section, a central section, and a lower section; and at least one thermochromic indicator disposed on at least one of the at least three sections but less than all of the at least three sections; wherein the at least one thermochromic indicator comprises a thermochromic material that changes from a first color to a second color at a certain temperature; wherein when the test tube is lowered below the certain temperature, the at least one thermochromic indicator changes to the second color. In another aspect, the at least one thermochromic indicator is disposed on the central section and the lower section of the test tube. In another aspect, the at least one thermochromic indicator is disposed on the central section only. In another aspect, the at least one thermochromic indicator is disposed on the lower section only. In another aspect, the first color is white or opaque. In another aspect, the second color is blue. In another aspect, the certain temperature is 0° C. In another aspect, the at least one thermochromic indicator changes from the second color to the first color during an experiment. In another aspect, when the upper portion of the test tube is handled by an instrument or user's hand, the at least one thermochromic indicator can be monitored to indicate when the second color changes to the first color during handling. In another aspect, the at least one thermochromic indicator comprises ink that is applied during manufacture of the test tube.

In the drawings, like numerals indicate like elements throughout. Certain terminology is used herein for convenience only and is not to be taken as a limitation on the present disclosure. The terminology includes the words specifically mentioned, derivatives thereof and words of similar import. The embodiments illustrated below are not intended to be exhaustive or to limit the disclosure to the precise form disclosed. These embodiments are chosen and described to best explain the principle of the disclosure and its application and practical use and to enable others skilled in the art to best utilize the disclosure.

The present disclosure can be understood more readily by reference to the instant detailed description, examples, and claims. It is to be understood that this disclosure is not limited to the specific systems, devices, and/or methods disclosed unless otherwise specified, as such can, of course, vary. It is also to be understood that the terminology used herein is for the purpose of describing particular aspects only and is not intended to be limiting.

The instant description of the disclosure is provided as an enabling teaching of the invention in its best, currently known aspect. Those skilled in the relevant art will recognize that many changes can be made to the aspects described, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the instant description is provided as illustrative of the principles of the present disclosure and not in limitation thereof.

As used herein, the singular forms “a,” “an” and “the” include plural referents unless the context clearly dictates otherwise. Thus, for example, reference to a “body” includes aspects having two or more bodies unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Although several aspects of the disclosure have been disclosed in the foregoing specification, it is understood by those skilled in the art that many modifications and other aspects of the invention will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure.

What is claimed is:

1. A method of assessing temperature change comprising:
providing a test tube comprising at least three sections, with the three sections including an upper section, a central section, and a lower section;
providing at least one thermochromic indicator on at least one of the at least three sections but less than all of the at least three sections; wherein the at least one thermochromic indicator comprises a thermochromic material that changes from a first color to a second color at a certain temperature; and,
lowering the test tube below the certain temperature to change the at least one thermochromic indicator to the second color.

2. The method of claim 1 wherein the at least one thermochromic indicator is disposed on the central section and the lower section of the test tube.

3. The method of claim 1 wherein the at least one thermochromic indicator is disposed on the central section only.

4. The method of claim 1 wherein the at least one thermochromic indicator is disposed on the lower section only.

5. The method of claim 1 wherein the first color is white or opaque.

6. The method of claim 1 wherein in the second color is blue.

7. The method of claim 1 wherein the certain temperature is 0° C.

8. The method of claim 1 wherein the method further comprises:
monitoring whether the at least one thermochromic indicator changes from the second color to the first color during an experiment.

9. The method of claim 1 further comprising:
handling the top portion with an instrument or user's hand; and
monitoring whether the at least one thermochromic indicator changes from the second color to the first color during handling.

10. The method of claim 1 wherein the at least one thermochromic indicator comprises ink that is applied during manufacture of the test tube.

11. A combination comprising:
a test tube comprising at least three sections, with the three sections including an upper section, a central section, and a lower section; and,
at least one thermochromic indicator disposed on at least one of the at least three sections but less than all of the at least three sections; wherein the at least one thermochromic indicator comprises a thermochromic material that changes from a first color to a second color at a certain temperature;
wherein when the test tube is lowered below the certain temperature, the at least one thermochromic indicator changes to the second color.

12. The combination of claim 11 wherein the at least one thermochromic indicator is disposed on the central section and the lower section of the test tube.

13. The combination of claim 11 wherein the at least one thermochromic indicator is disposed on the central section only.

14. The combination of claim 11 wherein the at least one thermochromic indicator is disposed on the lower section only.

15. The combination of claim 11 wherein the first color is white or opaque.

16. The combination of claim 11 wherein in the second color is blue.

17. The combination of claim 11 wherein the certain temperature is 0° C.

18. The combination of claim 11 wherein the at least one thermochromic indicator changes from the second color to the first color during an experiment.

19. The combination of claim 11 wherein, when the upper portion of the test tube is handled by an instrument or user's hand, the at least one thermochromic indicator can be monitored to indicate when the second color changes to the first color during handling.

20. The combination of claim 11 wherein the at least one thermochromic indicator comprises ink that is applied during manufacture of the test tube.
